(19) United States
(12) Patent Application Publication
(10) Pub. No.: US 2012/0145928 A1
(43) Pub. Date: Jun. 14, 2012

(54) ULTRAVIOLET CURING DEVICE FOR LIQUID CRYSTAL PANEL AND CURING METHOD THEREFOR

(75) Inventors: Yun Wang, Guangdong (CN); Chien-pang Lee, Guangdong (CN); Yu-wu Huang, Guangdong (CN); Bing-jei Liao, Guangdong (CN)

(73) Assignee: SHENZHEN CHINA STAR OPTOELECTRONICS TECHNOLOGY CO., LTD., Guangming New District, Shenzhen (CN)

(21) Appl. No.: 13/000,153

(22) PCT Filed: Dec. 8, 2010
(86) PCT No.: PCT/CN10/79549

§ 371 Date: Dec. 20, 2010

(51) Int. Cl. G01J 1/08; H01J 9/26

(52) U.S. Cl. 250/492.1; 445/25

(57) ABSTRACT

The present invention provides an ultraviolet curing device for a liquid crystal panel. The ultraviolet curing device has a sample platform and at least one ultraviolet-curing light source. The sample platform is used for placing a liquid crystal panel thereon. The ultraviolet-curing light source is mounted above the sample platform. The ultraviolet-curing light source has a radiation area smaller than an arrangement area of a sealant of the liquid crystal panel that is waiting to be cured by radiation of ultraviolet lights. The ultraviolet-curing light source moves above the sample platform and a surface of the liquid crystal panel and radiates at least one sealant of the liquid crystal panel under cured. The present invention further provides a corresponding ultraviolet curing method for a liquid crystal panel. The advantage of the present invention is to use movable light source performing a scan-type radiation to replace a fixed light source radiation of existing technology, so as to save the lamp number of ultraviolet-curing light source and thereby reduce manufacturing and maintaining cost on curing equipments and also save power.

### FIELD OF THE INVENTION

The present invention relates to a field of manufacturing liquid crystal display device, especially to an ultraviolet curing device for a liquid crystal panel and a curing method therefor.

### BACKGROUND OF THE INVENTION

In the present technology, the One Drop Filling (ODF) technique is usually used to fill a panel with liquid crystal for large size liquid crystal panels. This technique firstly drops evenly liquid crystal material on a surface of a lower glass substrate, and then uses a sealant dispenser to apply UV-cured sealant on the lower glass substrate. The lower glass substrate then is placed in a vacuum environment to perform alignment, sealing and curing with an upper glass substrate, and thereby assembling of cells of the liquid crystal panel is completed.

Presently foregoing operation of curing UV-cured sealant usually uses a UV radiation curing device. FIG. 1 is schematic view of a UV radiation curing device used for a liquid crystal panel according to a conventional technology. The UV radiation curing device includes a chamber 10, a plurality of ultraviolet lamps 11 and a panel 12, and the ultraviolet lamps 11 are placed in a lamp shell 13. The upper and lower glass substrates are aligned and laminated as a panel 12 by the ODF technique, and the panel 12 is placed in the chamber 10 which is used for ultraviolet radiation curing. The ultraviolet lamps 11 on a top of the chamber 10 emits ultraviolet lights to patterns formed by at least one sealant (not illustrated) that is waiting to be cured by ultraviolet lights on the panel 12, so as to perform ultraviolet radiation curing. The radiation energy of the ultraviolet lamps 11 can be measured by calculating accumulated ultraviolet light intensity: total energy (mj/cm²)=intensity (mw/cm²)×time (sec). The energy required by the conventional technology is usually 3000 J/cm².

A shortcoming of the conventional technology is that the ultraviolet lamps 11 need to have sufficient ultraviolet lights distributing over the entire surface of the panel. The ODF technique itself is especially suitable for large size panels, but for large size liquid crystal panels, it requires a large amount of ultraviolet lamps to satisfy the requirements of curing. Hence the manufacturing and maintaining cost of ultraviolet lamps of the curing device undoubtedly will be increased, and a large amount of ultraviolet lamps will use a large amount of electricity to work. Besides, in this amount of ultraviolet lamps, once one of them fails, the accumulated radiation quality will be affected and will relatively affect the yield rate of liquid crystal panels.

### SUMMARY OF THE INVENTION

In order to solve the above-mentioned technical problems, the present invention provides an ultraviolet curing device for a liquid crystal panel and a curing method therefor to decrease the amount of lamps for an ultraviolet-curing light source, so as to reduce manufacturing and maintaining cost on curing equipments and also save power.

To overcome the foregoing problems, the present invention provides an ultraviolet curing device for a liquid crystal panel, which comprises a sample platform and at least one first ultraviolet-curing light source. The sample platform is used for placing a liquid crystal panel thereon. The first ultraviolet-curing light source is mounted above the sample platform. The first ultraviolet-curing light source moves above the sample platform and a surface of the liquid crystal panel and radiates at least one sealant of the liquid crystal panel that is waiting to be cured by radiation, and the first ultraviolet-curing light source has a radiation area smaller than an arrangement area of the sealant of the liquid crystal panel that is waiting to be cured by ultraviolet radiation.

The present invention further provides an ultraviolet curing method for a liquid crystal panel, which comprises the following steps of:
placing a liquid crystal panel on a sample platform, wherein the liquid crystal panel has at least one sealant that is waiting to be cured; and using a ultraviolet-curing light source to move above a surface of the liquid crystal panel and radiates the sealant that is waiting to be cured, and so as to cure the sealant.

The advantage of the present invention is featured at using movable light source performing a scan-type radiation to replace a fixed light source radiation of existing technology, so as to save the amount of lamps of ultraviolet-curing light source and thereby reduce manufacturing and maintaining cost on curing equipments and also save power.

### DESCRIPTION OF THE DRAWINGS

FIG. 1 is a schematic view of an apparatus for ultraviolet curing for a liquid crystal panel according to a conventional technology;

FIG. 2 is a structural schematic view of a curing device of a first embodiment in accordance with the present invention;

FIG. 3 is a schematic view of implementation steps of a curing method of the first embodiment in accordance with the present invention;

FIG. 4 is a structural schematic view of a curing device of a second embodiment in accordance with the present invention; and

FIG. 5 is a schematic view of implementation steps of a curing method of the second embodiment in accordance with the present invention.

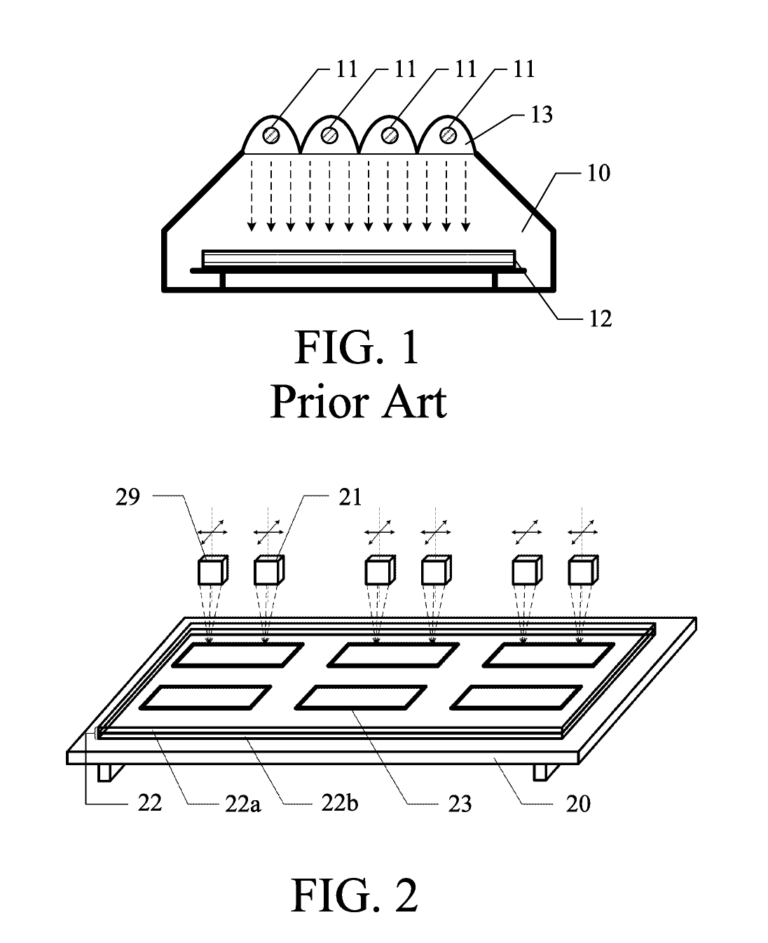

### DETAILED DESCRIPTION OF THE PREFERRED EMBODIMENTS

Detailed description is combined with drawings to describe the preferred embodiments of an ultraviolet curing device for a liquid crystal panel and curing method therefor in accordance with the present invention.

The foregoing objects, features and advantages adopted by the present invention can be best understood by referring to the following detailed description of the preferred embodiments and the accompanying drawings. The description provides different embodiments to describe technique features of different implementations of the present invention. The directional terms described in the present invention are only directions referring to the accompanying drawings, so that the used directional terms are used to describe and understand the present invention, but the present invention is not limited thereto.

In the present invention, an ultraviolet-curing curing light source of the ultraviolet curing device has a radiation area smaller than an arrangement area of an sealant of a liquid crystal panel waiting to be cured by ultraviolet radiation. The ultraviolet-curing light source moves above the sample platform and a surface of the liquid crystal panel to radiate the at least one sealant of the liquid crystal panel waiting to be cured by radiation. Because the radiation area of the ultraviolet-curing light source is much smaller, the amount of lamps required by the light source will be less than usual. Hence the amount of the lamps required by the ultraviolet-curing curing light source and the power consumption thereof will be reduced.

Correspondingly, the present invention provides an ultraviolet curing method comprising steps of: placing a liquid crystal panel on a sample platform, wherein the liquid crystal panel has at least one sealant waiting to be cured; and using at least one ultraviolet-curing light source to move above a surface of the liquid crystal panel and radiate the sealant waiting to be cured, so as to cure the sealant.

A first embodiment of the ultraviolet curing device for a liquid crystal panel and curing method of the present invention is described with drawings as follows:

FIG. 2 is a structural schematic view of a curing device of a first embodiment in accordance with the present invention. The curing device comprises a sample platform 20, a first ultraviolet-curing light source 21 and a second ultraviolet-curing light source 29. A liquid crystal panel 22 is placed on the sample platform 20, and the liquid crystal panel 22 has an upper glass substrate 22a and a lower glass substrate 22b. The first ultraviolet-curing light source 21 and the second ultraviolet-curing light source 29 are mounted above the sample platform 20 and the liquid crystal panel 22. The liquid crystal panel 22 has a plurality of sealants 23 (six sealants in this embodiment), and the sealants 23 are disposed between both of the glass substrates 22a and 22b of the liquid crystal panel 22. A room surrounded by the sealants 23 is filled with liquid crystal by ODF technique. An object of the device and the method is to ensure that the liquid crystal is sealed inside and not going to leak out. Widths of the sealants 23 may be ranged between 0.5 mm and 2 mm. A shape of each of the sealant 23 may be any common geometric shape, such as a circle or a polygon.

The first ultraviolet-curing light source 21 can move along a direction parallel with the sample platform 20 and a surface of the liquid crystal panel 22 via robot arms or other equivalent mechanisms, as shown by the solid arrows in FIG. 2 (dashed arrows represent directions of lights). In this embodiment, the radiation area that the first ultraviolet-curing light source 21 forms on the liquid crystal panel 22 is a round point (not illustrated). The diameter of the round point is not greater than a width of the sealant 23 of the liquid crystal panel 22 waiting to be cured. Therefore, in the process that the first ultraviolet-curing light source 21 moves along the sealant 23 to radiate the sealant 23, the radiation area will not be out of a range limited by the sealant 23, so that the liquid crystal material which is filled by ODF technique will not be affected. Hence, the diameter of the round point is preferably equal to the width of the sealant 23, such that curing efficiency of the light source can be enhanced.

In other embodiments, the radiation area may be any common geometric shape, such as a bar-shape or a polygon, but no matter what shape it is, the width of the radiation area that the first ultraviolet-curing light source forms on the liquid crystal panel should not be greater than the width of the sealant of the liquid crystal panel waiting to be cured, so that the first ultraviolet-curing light source can perform a moving radiation on the sealant. Generally speaking, as for a pattern, we should define a longer-directional dimension as a length, and a shorter-direction dimension as a width, which is a common definition means. A width described here is the minimum dimension of the pattern among all of the dimensions with different directions, for example, as for a rectangle shape, the width should be the length of the shorter edge thereof; and as for a regular hexagon, the width should be the distance between two parallel edges.

The embodiment further includes the second ultraviolet-curing light source 29. The second ultraviolet-curing light source 29 and the first ultraviolet-curing light source 21 move along an identical path one after the other to radiate the same sealant 23, so as to enhance the curing effect that the first ultraviolet-curing light source 21 performs on the sealant 23. With reference to FIG. 2, the first ultraviolet-curing light source 21 and the second ultraviolet-curing light source 29 may be arranged side by side. When the first ultraviolet-curing light source 21 finishes scanning one of the sealants and turns to next one of the sealants, the second ultraviolet-curing light source 29 then follows the first ultraviolet-curing light source 21 to the next one of the sealants. The same with the first ultraviolet-curing light source 21, a width of the radiation area that the second ultraviolet-curing light source 29 performs on the liquid crystal panel 22 is not greater than the width of the sealants 23, so as to ensure that the radiation area will not be out of the range limited by the sealants 23, so that the liquid crystal material which is filled by ODF technique will not be affected. The width of the radiation area that the second ultraviolet-curing light source 29 performs on the liquid crystal panel 22 is preferably equal to the width of the sealant 23, such that curing efficiency of the light source can be enhanced.

With reference to FIG. 2, the liquid crystal panel 22 may have a plurality of the sealants 23, and with respect thereto, the first ultraviolet-curing light source 21 and the second ultraviolet-curing light source 29 have a plurality of corresponding mechanisms. The first ultraviolet-curing light source 21 and the second ultraviolet-curing light source 29 independently move along and radiate the corresponding sealants 23 of the liquid crystal panel 22, respectively, so as to simultaneously perform curing on a plurality of areas of the liquid crystal panel 22 to enhance curing efficiency.

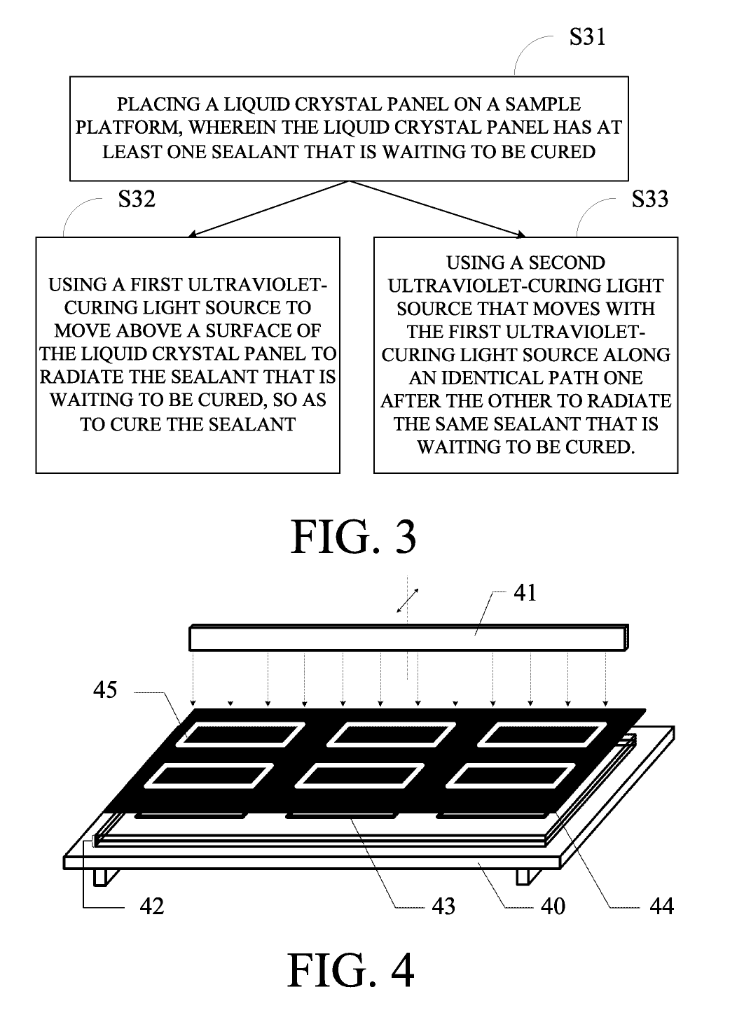

FIG. 3 is a schematic view of implemented steps of curing method according to the embodiment. The curing method that uses the aforementioned device to perform curing process mainly comprises two steps of: Step of S31: placing a liquid crystal panel on a sample platform, wherein the liquid crystal panel has at least one sealant that is waiting to be cured; and Step of S32: using a first ultraviolet-curing light source to move above a surface of the liquid crystal panel to radiate the sealant that is waiting to be cured, so as to cure the sealant. When implementing step of S32, a step of S33 can be selectively implemented: using a second ultraviolet-curing light source that moves with the first ultraviolet-curing light source along an identical path one after the other to radiate the same sealant that is waiting to be cured.

The implementation of the steps in FIG. 3 is simultaneously referred to the device described in FIG. 2.

In the step of S31, the width of the sealant may be ranged between 0.5 mm and 2 mm.

In the step of S32, the width of the radiation that the first ultraviolet-curing light source forms on the liquid crystal panel is preferably not greater than the width of the sealant of the liquid crystal panel waiting to be cured, and is further preferably equal to the width of the sealant of the liquid crystal panel waiting to be cured.

In the step of S33, the width of the radiation that the second ultraviolet-curing light source forms on the liquid crystal panel is preferably not greater than the width of the sealant of the liquid crystal panel waiting to be cured, and is further preferably equal to the width of the sealant of the liquid crystal panel waiting to be cured.

In the steps of S32 and S33, velocity of the ultraviolet-curing light sources can be calculated according to the total amount of light for curing the sealants and the brightness emitted by the first and the second ultraviolet-curing light sources, to ensure the sealants can be fully cured. Apparently, in order to increase the velocity of the light sources to save work time, high-brightness ultraviolet light sources are preferably used.

With reference to FIG. 2, in this embodiment, the sealants are a plurality of rectangular patterns, therefore the first and the second ultraviolet-curing light sources may firstly scan one of the sealants, then to scan another one of the sealants. In FIG. 2, a plurality of assemblies of the first and the second ultraviolet-curing light sources are implemented. Hence, the amount of the sealants can be distributed to each of assemblies of the ultraviolet-curing light sources to work simultaneously to reduce work time. In other embodiments, scanning paths of the ultraviolet-curing light sources should be appropriately designed according to the practical shapes and arrangements of the sealants and the number of the assemblies of the ultraviolet-curing light sources for scanning all over the sealants in a short time.

Further description of the above steps can be referred to the foregoing description of the curing device in FIG. 2.

As mentioned above, the first embodiment uses movable light sources performing a scan-type radiation to replace a fixed light source radiation of existing technology, so as to save the lamp number of the ultraviolet-curing light sources and thereby reduce manufacturing and maintaining cost on curing equipments and also save power.

Hereafter a second embodiment of the present invention with accompanying drawings is disclosed.

FIG. 4 is a structural schematic view of the curing device of the second embodiment in accordance with the present invention. The curing device comprises a sample platform 40, a bar-shaped ultraviolet-curing light source 41 and a mask 44. A liquid crystal panel 42 is placed on the sample platform 40, and the liquid crystal panel 42 has sealants 43. The mask 44 has a plurality of light penetrable mask patterns 45. The bar-shaped ultraviolet-curing light source 41 is mounted above the sample platform 40 and mask 44. The liquid crystal panel 42 in FIG. 4 and the liquid crystal panel in FIG. 2 are identical, therefore the structure of the sealants of the liquid crystal panel 42 that is concealed by the mask can be referred to FIG. 2, and is no longer illustrated.

The mask 44 is disposed between the bar-shaped ultraviolet-curing light source 41 and the liquid crystal panels 42, and the ultraviolet lights of the bar-shaped ultraviolet-curing light source 41 are emitted to the liquid crystal panel 42 through the mask 44. A gap preferably exists between the mask 44 and the liquid crystal panel 42, so as to prevent the mask 44 from scratching the surface of the liquid crystal panel 42.

The mask 44 has the light penetrable mask patterns 45, and the light penetrable mask patterns 45 on the mask 44 correspond to the shapes of the sealants 43 of the liquid crystal panel 42 waiting to be cured. In order to ensure that the sealants 43 can be radiated, certain portions of the mask 44 corresponding to the sealants waiting to be cured are pervious.

The bar-shaped ultraviolet-curing light source 41 can reciprocally move along a direction parallel with the sample platform 40 and the surface of the liquid crystal panel 44, as shown by the solid arrows in FIG. 4 (dashed arrows represent directions of lights), so as to perform a moving radiation to the sealants 43.

In the process of the bar-shaped ultraviolet-curing light source 41 performing the moving radiation, an arrangement direction of the bar-shaped ultraviolet-curing light source 41 should ensure that a longer edge thereof is parallel with the edge of the sealants 43. In this embodiment, each of the sealants is rectangular; hence the so-called edge may be any edge of two parallel side of the rectangular shape. During the moving radiation, the bar-shaped ultraviolet-curing light source 41 moves along a direction that is perpendicular to the longer edge thereof.

In other embodiments, any edge of one of the sealants 43 can be selected according to the practical shape of the sealants, such that the bar-shaped ultraviolet-curing light source 41 is arranged to have the longer edge thereof to be parallel with the selected edge, and a moving direction is perpendicular to the selected edge.

In this embodiment, the device is obtained by reconstructing a screen print apparatus, which mainly use the bar-shaped ultraviolet-curing light source 41 to replace a high-brightness LED light bar that is mounted on a scraper in the screen print apparatus, so that work cost can be reduced since new device is obtained by reconstructing existing apparatus. The bar-shaped ultraviolet-curing light source 41 is constructed by a plurality of array-arranged-ultraviolet-LED light bars. The advantages of the ultraviolet LED are featured at small volume and easy to assemble and dismantle. In other embodiments, any common light source in the related field, such as an ultraviolet fluorescent lamp, can be selected as the bar-shaped ultraviolet-curing light source 41.

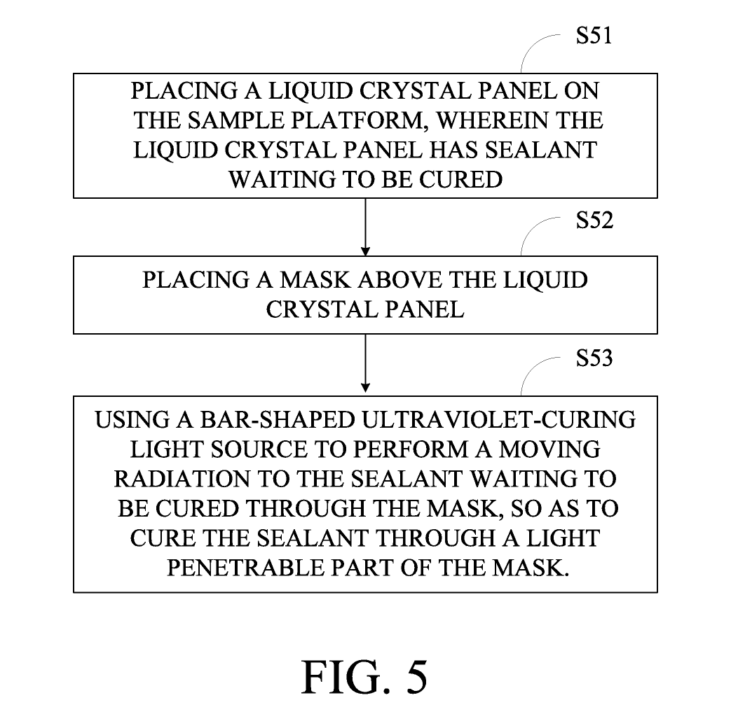

FIG. 5 is a schematic view of implementation steps of the curing method of this embodiment. The curing method applying the foregoing device to perform curing on the liquid crystal panel 42 mainly comprises three steps of: step of S51: placing a liquid crystal panel on the sample platform, wherein the liquid crystal panel has sealant waiting to be cured; step of S52: placing a mask above the liquid crystal panel; and step of S53: using a bar-shaped ultraviolet-curing light source to perform a moving radiation to the sealant waiting to be cured through the mask, so as to cure the sealant through a light penetrable part of the mask.

The implementation of the steps in FIG. 5 is simultaneously referred to the device described in FIG. 4.

In the step of S52, the light penetrable mask patterns of the mask correspond to the sealants of the liquid crystal panel waiting to be cured, and are preferably light penetrable through holes. A gap exists between the mask and the liquid crystal panel.

In the step of S53, the longer edge of the bar-shaped ultraviolet-curing light source is parallel with one of the edges of the sealants, and the bar-shaped ultraviolet-curing light source moves along a direction that is perpendicular to the longer edge thereof. In other embodiments, any edge of one of the sealants can be selected according to the practical shape of the sealants, such that the bar-shaped ultraviolet-curing light source is arranged to have the longer edge thereof to be parallel with the selected edge, and a moving direction of the bar-shaped ultraviolet-curing light source is perpendicular to the selected edge.

In the step of S53, the bar-shaped ultraviolet-curing light source is a light bar constructed by a plurality of array-arranged ultraviolet LEDs.

Further description of the above steps can be referred to the foregoing description of the curing device in FIG. 4.

As the above-mentioned, the second embodiment uses movable bar-shaped ultraviolet-curing light sources combined with mask to perform a scan-type radiation to replace a fixed light source radiation of existing technology, so as to save the lamp number for ultraviolet-curing, and thereby reduce manufacturing and maintaining cost for curing equipments and also save power.

The present invention has been described with a preferred embodiment thereof and it is understood that many changes and modifications to the described embodiment can be carried out without departing from the scope and the spirit of the invention that is intended to be limited only by the appended claims.

1. An ultraviolet curing device for a liquid crystal panel, comprising a sample platform, a first ultraviolet-curing light source and a second ultraviolet-curing light source, wherein the sample platform is used for placing a liquid crystal panel thereon, and the first ultraviolet-curing light source is mounted above the sample platform, characterized in that:
the first ultraviolet-curing light source moves above the sample platform and a surface of the liquid crystal panel and radiates at least one sealant of the liquid crystal panel that is waiting to be cured by radiation, and the first ultraviolet-curing light source has a radiation area having a width which is not greater than a sideline width of the sealant of the liquid crystal panel;
the second ultraviolet-curing light source and the first ultraviolet-curing light source move along an identical path one after the other to radiate the same sealant, and the widths of the radiation areas of the first ultraviolet-curing light source and the second ultraviolet-curing light source are ranged between 0.5 mm and 2 mm.

2. An ultraviolet curing device for a liquid crystal panel, comprising a sample platform and at least one first ultraviolet-curing light source, wherein the sample platform is used for placing a liquid crystal panel thereon, and the first ultraviolet-curing light source is mounted above the sample platform, characterized in that: the first ultraviolet-curing light source moves above the sample platform and a surface of the liquid crystal panel and radiates at least one sealant of the liquid crystal panel that is waiting to be cured by radiation, and the first ultraviolet-curing light source has a radiation area which is smaller than an arrangement area of the sealant of the liquid crystal panel that is waiting to be cured by ultraviolet radiation.

3. The ultraviolet curing device as claimed in claim 2, characterized in that:
the radiation area of the first ultraviolet-curing light source to the liquid crystal panel has a width which is not greater than a sideline width of the sealant.

4. The ultraviolet curing device as claimed in claim 2, characterized in that:
further comprising a second ultraviolet-curing light source which is arranged with the first ultraviolet-curing light source side by side, both of which move along an identical path one after the other to radiate the same sealant.

5. The ultraviolet curing device as claimed in claim 2, characterized in that:
further comprising at least one second ultraviolet-curing light source, wherein the second ultraviolet-curing light source and the first ultraviolet-curing light source are independent of each other; the liquid crystal panel has at least two of the sealants on the surface thereof; and the first ultraviolet-curing light source and the second ultraviolet-curing light source independently move along and radiate the corresponding sealants of the liquid crystal panel, respectively.

6. The ultraviolet curing device as claimed in claim 4, characterized in that:
the radiation area of the second ultraviolet-curing light source to the liquid crystal panel has a width which is not greater than a sideline width of the sealant.

7. The ultraviolet curing device as claimed in claim 5, characterized in that:
the radiation area of the second ultraviolet-curing light source to the liquid crystal panel has a width which is not greater than a sideline width of the sealant.

8. The ultraviolet curing device as claimed in claim 2, characterized in that:
the first ultraviolet-curing light source is a bar-shaped ultraviolet-curing light source; the ultraviolet curing device further has a mask, and the mask is disposed between the bar-shape ultraviolet-curing light source and the liquid crystal panel; ultraviolet lights emitted from the bar-shaped ultraviolet-curing light source pass through the mask and radiate the sealant of the liquid crystal panel waiting to be cured by radiation; a shape of at least one light penetrable mask pattern of the mask corresponds to a shape of the sealant of the liquid crystal panel; and the bar-shaped ultraviolet-curing light source reciprocally moves above the mask, so as to perform a moving radiation to the sealant under the mask.

9. The ultraviolet curing device as claimed in claim 2, characterized in that:
the ultraviolet-curing light source is a light bar which is constructed by a plurality of array-arranged ultraviolet LEDs.

10. The ultraviolet curing device as claimed in claim 8, characterized in that: a gap exists between the mask and the liquid crystal panel.

11. An ultraviolet curing method for a liquid crystal panel, characterized in that:
comprising the following steps of:
placing a liquid crystal panel on a sample platform, wherein the liquid crystal panel has at least one sealant waiting to be cured; and
using at least one ultraviolet-curing light source to move above a surface of the liquid crystal panel and radiate the sealant waiting to be cured, so as to cure the sealant.

12. The ultraviolet curing method as claimed in claim 11, characterized in that:
a radiation area of the ultraviolet-curing light source to the liquid crystal panel has a width which is not greater than a sideline width of the sealant.

13. The ultraviolet curing method as claimed in claim 11, characterized in that:
the step of using the ultraviolet-curing light source to move above the surface of the liquid crystal panel and radiate the sealant is to use at least two of the ultraviolet-curing light sources arranged side by side to move along an identical path one after the other to radiate the same sealant; or
the step of using the ultraviolet-curing light source to move above the surface of the liquid crystal panel and radiate the sealant is to use at least two of the ultraviolet-curing light sources independent of each other, wherein the liquid crystal panel has at least two of the sealants on the surface thereof; and the ultraviolet-curing light sources independently move along and radiate the corresponding sealants of the liquid crystal panel, respectively.

14. The ultraviolet curing method as claimed in claim 13, characterized in that:
the step of using the ultraviolet-curing light source to move above the surface of the liquid crystal panel and radiate the sealant is to use at least two of the ultraviolet-curing light sources arranged side by side to move along an identical path one after the other to radiate the same sealant; or
the step of using the at least one ultraviolet-curing light source to move above a surface of the liquid crystal panel and radiate the sealant is to use at least two of the ultraviolet-curing light sources independent of each other, wherein the liquid crystal panel has at least two of the sealants on the surface thereof; and the ultraviolet-curing light sources independently move along and radiate the corresponding sealants of the liquid crystal panel, respectively.

15. The ultraviolet curing method as claimed in claim 11, characterized in that:
further comprising the following steps of:
placing a mask above the liquid crystal panel, wherein a shape of a light penetrable mask pattern of the mask corresponds to a shape of the sealant of the liquid crystal panel; and
using ultraviolet lights emitted from a bar-shaped ultraviolet-curing light source to perform a moving radiation to the sealant waiting to be cured through the light penetrable mask pattern of the mask, so as to cure the sealant.
